(19) United States
(12) Patent Application Publication
(10) Pub. No.: US 2023/0413084 A1
(43) Pub. Date: Dec. 21, 2023

(54) System and Method for Determining Wireless Service Quality using Inference

(71) Applicant: 7SIGNAL, INC., Independence, OH (US)

(72) Inventors: Joseph Tennant, Wadsworth, OH (US); Theodor Schneider, New Albany, OH (US); James Vajda, Oxford, OH (US); Simon Renouf, Franklin, TN (US)

(73) Assignee: 7SIGNAL, INC., Independence, OH (US)

(21) Appl. No.: 18/333,298

(22) Filed: Jun. 12, 2023

Related U.S. Application Data
(60) Provisional application No. 63/353,766, filed on Jun. 20, 2022.

(51) Int. Cl. H04W 24/08; H04L 1/00

(52) U.S. Cl. CPC H04W 24/08; H04L 1/0003; H04L 1/0009

(57) ABSTRACT

A method of determining wireless service quality in a shared environment includes receiving a wireless transmission from a client device in the shared environment and processing the received wireless transmission to determine a client modulation-and-coding scheme and a client device attribute associated with the client device. A rank of the client device is calculated using the client sample wherein the rank is based on a universal index that is related to the client modulation-and-coding scheme and related to the client device attribute. A wireless service quality of the shared environment is then inferred based on the calculated rank of the client device.

### CROSS REFERENCE TO RELATED APPLICATIONS

The present application is a non-provisional application of U.S. Provisional Patent Application No. 63/353,766, entitled “Method to Accurately Inferring Wi-Fi Link Quality”, filed on Jun. 20, 2022. The entire content of U.S. Provisional Patent Application No. 63/353,766 is herein incorporated by reference.

The section headings used herein are for organizational purposes only and should not be construed as limiting the subject matter described in the present application in any way.

### INTRODUCTION

Wireless networks are central to providing communications capability for numerous different business activities in diverse industries including, for example, education, retail, manufacturing, government, enterprise, financial, and healthcare. This includes operation in small and large venues, to include conference centers, arenas, and stadiums. Providing a quality wireless experience for the diversity of client devices that operate across and within this broad range of wireless network environments requires improvements in wireless monitoring and management technology.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale; emphasis instead generally being placed upon illustrating principles of the teaching. The drawings are not intended to limit the scope of the Applicant's teaching in any way.

FIG. 1 illustrates a block diagram of an embodiment of an architecture of a network service management system for distributed wireless client devices of the present teaching.

FIG. 2 illustrates an embodiment of a multi-network network service management system of the present teaching.

FIG. 3 illustrates an embodiment of a mobile wireless service quality test device of the present teaching.

FIG. 4 illustrates an embodiment of a system architecture for a distributed network service performance management system of the present teaching.

FIG. 5 illustrates an embodiment of a system architecture for a distributed network service performance management system that uses services levels to control the volume and flow of network testing traffic of the present teaching.

FIG. 6 illustrates an embodiment of a data capture system for a client device that does not support data capture of the present teaching.

FIG. 7 illustrates an embodiment of an architecture of a system for wireless performance monitor using a wireless performance monitor device that is separate from monitored client devices of the present teaching.

FIG. 8 illustrates an embodiment of an architecture of a distributed network service performance management system including a wireless performance monitor that is separate from the monitored client devices of the present teaching.

FIG. 9 illustrates a table that connects specific modulation coding schemes that includes both the modulation scheme and the coding scheme to a quality score.

FIG. 10 illustrates a functional block diagram of an embodiment of a system of the present teaching for determining wireless platform quality using inference.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teaching can be performed in any order and/or simultaneously as long as the teaching remains operable. Furthermore, it should be understood that the apparatus and methods of the present teaching can include any number or all of the described embodiments as long as the teaching remains operable.

Wireless networks are a foundational part of communications technology. Many wireless systems and devices do not report a modulation and coding system in use directly. Further, modulation and coding scheme scales vary across the industry standards, such as WiFi standard IEEE 802.11. As such, systems and methods are needed to allow network service quality measurement and management systems to determine modulation and coding systems in a variety of distributed and/or aggregated heterogeneous wireless networks to determine a wireless quality of a particular device or platform in those environments.

Current methodologies for network service performance management are substantially limited in numerous ways, including, but not limited to, their ability to obtain accurate data regarding network performance at all levels, their ability to integrate those data to determine and optimize overall network performance, and their ability to identify, troubleshoot, and improve areas of poor network performance. Current methodologies further rely on testing and data gathering performed by a central server, which leads to bandwidth resource issues and unnecessary data storage and processing costs. Current methodologies are also limited by a lack of direct service quality information available from client devices themselves owing to, for example, proprietary operating systems, inconsistent standards and other reasons. A distributed network performance management system and method that distributes a large portion of the network performance management to wireless client devices connected to the network is needed that can address these and other issues.

One aspect of the present teaching is that the distributed network service performance management system and method of the present teaching can distribute at least a portion of the network performance management to wireless client devices connected to the network. In particular, such systems can automatically recognize and adapt to limitations within some or all of those client devices so as to provide high quality service performance information necessary to improve system operation. In addition, rather than relying on a central server to perform all or most of network performance management, a distributed network performance management system according to the present teaching can offload much of the work of service quality testing, reporting, and troubleshooting to wireless client devices that are connected to the network. Furthermore, systems according to the present teaching can utilize spare computing power and storage space on the wireless client devices to reduce the cloud operation costs of the system including, for example, cost for bandwidth requirements, data storage requirements, and data processing requirements.

Another aspect of the present teaching is that all or some of the locus of control of network performance management may be shifted up, or down, the hierarchy of system components, including the server, the access points, external monitors and client devices, as needed. In some embodiments, systems according to the present teaching employ client service levels and optimization algorithms to dynamically adjust the level of sampling detail gathered in response to certain network conditions. In other embodiments, the system uses multi-factor event correlation to infer network conditions that are not directly measurable or identifiable. In yet other embodiments, the system uses improved wireless client device system driver data capture and analysis to obtain accurate measurements of device-specific network performance, even where such device-specific network performance is not supported by the client device or the wireless access point to which the client device is connected. Examples of some features and configurations for the above embodiments are found in U.S. Pat. No. 10,939,312B2, which is assigned to the present assignee and which is incorporated herein by reference.

An additional limitation for known network performance management systems is that most operating systems within client devices do not directly report the modulation and coding system in use. Also, some client devices do not have sufficient computing resources to report the modulation and coding system in use. These limitations of client devices, together with the fact that modulation and coding scheme scales vary across the various standards in use, including, for example, the IEEE 802.11 standard, prevents the aggregation of values of operating parameters from wireless client devices that have different capabilities.

Furthermore, the inability to aggregate results from a diverse and distributed group of client devices prevents a network performance management system from using those measurements together to describe the quality of an RF environment shared by those clients. Embodiments of the method and system of determining wireless quality using inference according to the present teaching and described herein can address these, and other, limitations of known wireless network management systems.

It should be understood that embodiments of the system and method present teaching described herein are shown in connection with various example device and system configurations and architectures to illustrate the key features and functions of the present teaching. However, as will be understood by those skilled in the art, the systems and methods of the present teaching are not limited to any particular device and system configuration. Other wireless network system and device configurations and architectures than those explicitly described herein can be used within the spirit and scope of the present teaching.

Many aspects of following description are described in connection with wireless communication. However, it should be understood that various aspects of the present teaching also apply to wired communications, such as devices that are hard wired to networks through Ethernet connections or similar computer wired networks protocols.

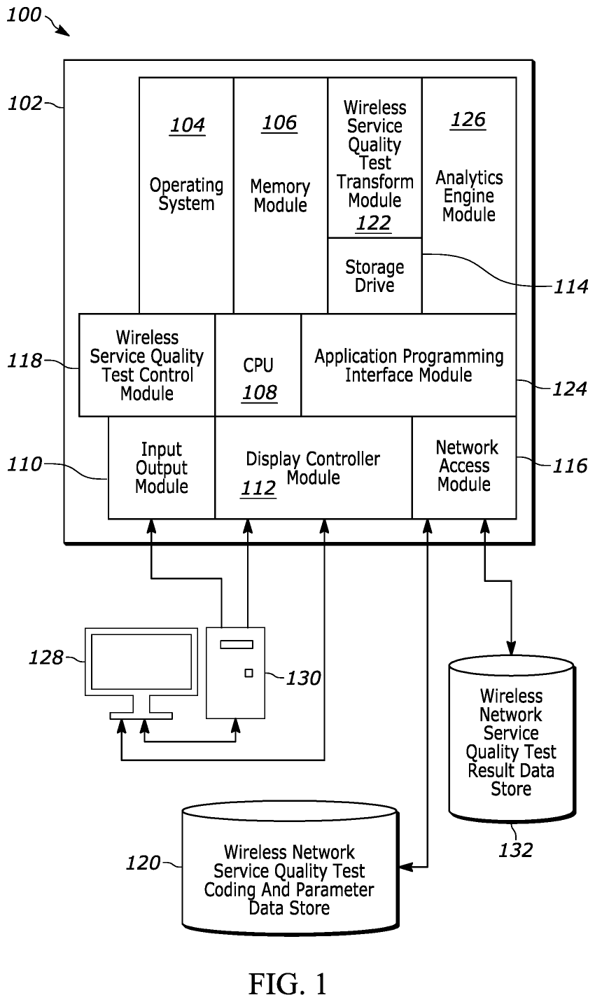

FIG. 1 illustrates a block diagram of an embodiment of an architecture of a network management system 100 for distributed wireless client devices (not shown) of the present teaching. The system 100 includes a central controller 102. The controller 102 can include an operating system 104, memory 106, central processing unit (CPU) 108, input-output (I/O) controller 110, display controller 112, storage drive 114 and wired network access module 116. In addition to these components, the central controller 102 can also include a wireless service quality test control module 118 configured to receive and process customer specified test suites and modification parameters from a centralized and/or cloud based wireless network service quality test coding and parameter data store 120 that is connected via the network access module 116. The wireless service quality test control module 118 can use that received information to configure a plurality of mobile wireless network service quality test devices. In some embodiments, the wireless service quality test control module 118 can include the central controller itself. This allows one or more of the mobile wireless network service quality test devices to run the test suites and collect the correct, customer-requested data.

A wireless service quality test transform module 122 can receive wireless network performance test data and perform specific preprogrammed algorithms to establish performance levels. For example, the algorithms can use multiple aspects of wireless network operations additional data received from third party sources (not shown), such as wireless access points within the probed wireless network. An application programming interface (API) module 124 can also provide input to the wireless service quality test transform module 122. An analytics engine module 126 can perform calculations on test and other data using the preprogrammed algorithms. Results can be shown to end users on an optional system interaction display 128, which can range from a dedicated display and keyboard on the central server to a serial or network attached workstation 130. The results can be provided in one or more of numerous known formats specified by an end user.

In some embodiments, efficiencies in network performance compared to customer service level requirements, and/or other benchmarks, invoke the collection of additional information through a mobile wireless network service quality test device (not shown) that communicates with third party devices through the application programming interface 124. In some embodiments, gathered data can be submitted to the analytics engine module 126. As one example, the analytics engine module 126 can combine the gathered data with data obtained from wireless equipment manufacturers and vendors, and data stored from past test wireless network runs to formulate a root cause. Some embodiments of the present teaching use predictive algorithms. Notifications, warnings and alarms specified by the customer can also be implemented. Various data can be saved in a data store 132 for possible further analysis and record keeping. The data store 132 can be, for example, a cloud-based data store, a local data store, or some combination of these.

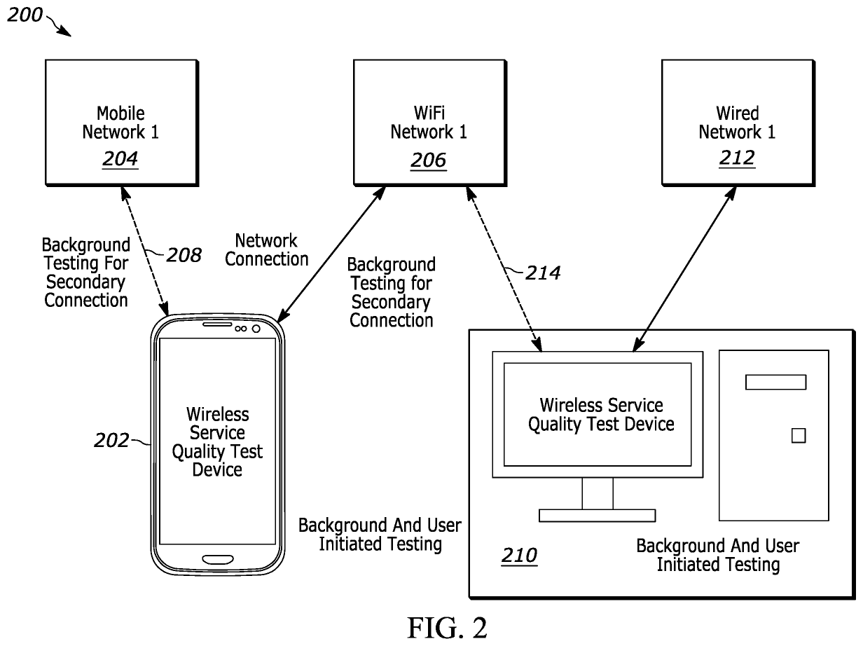

One feature of the present teaching is that it can be used in connection with multiple wireless and/or wired networks. These networks can share some or all of a physical location, and therefore participate in the same, or related, wireless environment. FIG. 2 illustrates an embodiment of a multi-network network service management system 200 of the present teaching. The system 200 supports both passive and active testing of more than one wireless network by wireless network service quality test devices 202. A wireless client test device 202, e.g., a cell phone, is connected to two wireless networks 204, 206, that is a mobile cellular network 204 and a WiFi network 206. The wireless client device 202 can run tests on these two separate networks 204, 206 within a single test suite residing in the device 202. For example, a wireless phone provider network connection 208, can be tested actively via attempts to connect to designated phone exchanges, to download designated data and/or to connect to designated servers and web pages. In various embodiments, the testing can be active and/or passive, for example, measurements of signal strength at test location, signal-to-noise ratios, radio and connect acknowledgement latency.

In some methods, the results can be reported to the phone service provider's quality management as well as client corporate analysts once connection with the WiFi network 206 is reestablished at the conclusion of mobile network 204 testing. In some methods, the remote test device and the wireless client device 202 may have simultaneous dual RF radio capability, in which case one wireless network can be probed and the resultant data immediately sent to a network management system for distributed wireless client devices to make results available to an end user. This can be, for example, the system 100 that includes a central controller 102, described in connection with FIG. 1.

Alternatively, or in addition, a remote test device 202 (which can be the wireless client device 202 or a similar device) with only single RF capability may disconnect from the first network 204 and connect to the second network 206 to be tested, while probing the network, and then store the resultant data. Upon completion of inspection of the second network, the remote test device 202 may disconnect from the second network, re-connect to the first network 204, and then send all of the stored result data to a network management system for distributed wireless client devices to make results available to an end user. This can be, for example the system 100 that includes a central controller 102, described in connection with FIG. 1.

A second network service quality test device 210 with both wireless network 206 and wired network 212 connection capabilities may be used to initiate and execute interactive and background network performance tests 208, 214. Such test can be active such as data throughput, retry number, and/or ping return time. The second network service quality test device 210 can also initiate and execute interactive and background network performance tests 208, 214 using passive techniques, such as deep packet inspection, packet capture, and protocol analysis, packet drop rates, and wireless radio channel usage in manners similar to those described herein.

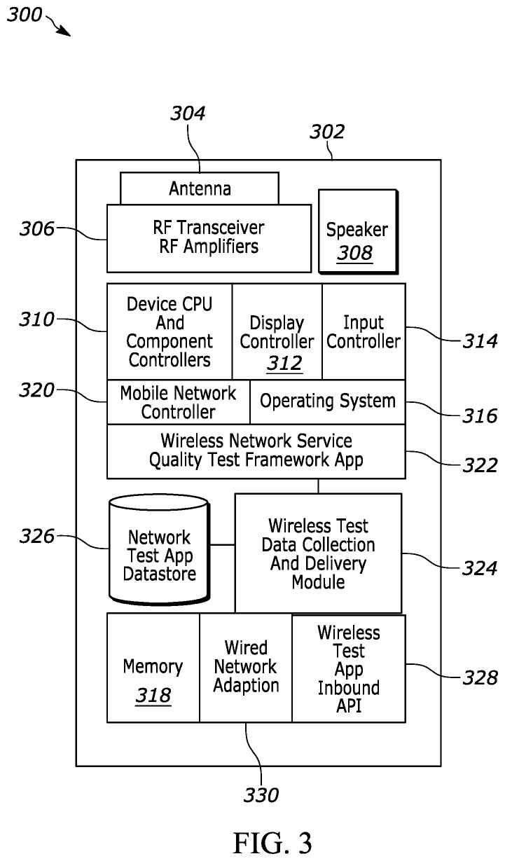

FIG. 3 illustrates an embodiment of a mobile wireless service quality test device 300 of the present teaching. Residing in the device boundary 302, which in some embodiments is a cellphone case, are: an antenna 304, RF transceiver and amplifiers 306, speaker 308, CPU and assorted device controllers 310, display controller 312, input controller 314, operating system 316, memory 318, and mobile network controller 320. These elements are similar to those found in various known wireless phone and data network connecting devices. A display, such as an LCD display, is not depicted for simplicity. The device 300 can operate as a wireless network performance probe through use of wireless network service quality test framework application 322, which can run various simple network performance tests as a standalone device and can also run a larger number of tests as directed by a central controller (not shown). In some embodiments, tests are run using the wireless test data collection and delivery module 324. Results of each test can include, but are not limited to, steady state signal strength, variability in signal strength, signal-to-noise ratio, current percentage of network traffic versus network capacity, radio attachment latency, resource request latency, location of the test device, and ping response time.

The wireless network test device 300 may also disconnect from a primary network (not shown) temporarily to perform such tests as packet analysis and to scan the radio bandwidths used by the customer's wireless network for interference, multi-path effects. Similarly, the wireless network test device 300 may disconnect from an internal wireless network (not shown) to measure the signal strength, connection latency and data rate of the customer's mobile phone provider's voice and data connection. The mobile wireless network test device 300 includes a data store 326 for storing of network test applications and data. When connected to a central controller (not shown), the wireless test data collection and delivery module 324 retrieves the stored data from the network test application data store 326 and transmits it to the central controller. In some embodiments, the mobile wireless test device may send information inquiries to known high-volume web sites such as, but not limited to FACEBOOK™, SKYPE™ CHROME™ and GOOGLE™ using wireless test application inbound API 328 as part of a test suite.

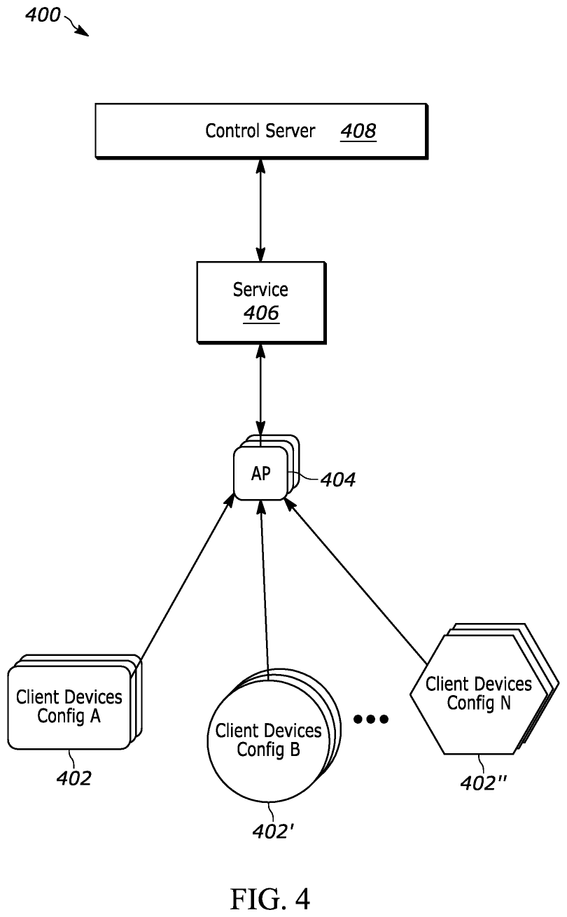

FIG. 4 illustrates an embodiment of a system architecture for a distributed network performance management system 400 of the present teaching. The system 400 can operate independently, as part of a pre-existing ecosystem, or as part of a centralized, single-purpose service. One or more client devices 402, 402′, 402″ have different configurations, devices 402 having configuration A, devices 402′ having configuration B and devices 402″ having configuration N, where N can be any number, connect via one or more access points 404 to a common service 406. One example of a different configuration is using a different operating system. Another example of a different configuration is using a different platform. By platform we mean an operating system and associated hardware. In addition, or alternatively, other device configuration parameters can also be different in different configurations.

The service 406 is connected to a control server 408. The system 400 is shown as including one service 406 for clarity, but is not limited to one service. Because of the distributed nature of the system 400, computing and storage resources can be allocated to any level of the system, from the control server 408 to the client devices 402, 402′, 402″. This allocation can be based on network conditions. Network conditions can include, for example, outages of sub-servers and services 406, access points 404, and connections/disconnections of client devices 402, 402′, 402″. Network conditions also can include, for example, availability of online resources such as bandwidth, storage capacity, processing capacity.

In some embodiments of the system 400, computing and storage resources can be dynamically re-allocated during operation, shifting them up and down between the control server 408, services 406, and client devices 402, 402′, 402″, as network conditions change. Thus, the locus of control of the system and the location of processing and analysis may be shifted up or down the hierarchy of system components as needed. This can be implemented by causing the control server to issue a set of configuration instructions comprising a level of autonomy authorized for each client device 402, 402′, 402″ and/or AP 404 and/or service 406.

The level of autonomy can range from minimal to maximal. Minimal autonomy can include, for example, reporting and testing based on tests that are pre-selected in the configuration instructions and schedules pre-defined in the configuration instructions. Maximal autonomy can include, for example, the device itself determining, based on an application running on the device, what tests to select and perform, when to perform the tests, what test result data to store, whether and how often to report to the control server, and how to dynamically change the frequency (i.e., periodicity of testing) and granularity (i.e., level of detail captured during testing) of testing based on changing network conditions.

In some embodiments, analytic and control functions may be shifted to certain layers or levels of the hierarchy. For example, keeping track of the number of clients 402, 402′, 402″ that should provide sample data for an access point 404 may be managed by a computing device at any level (i.e., by one of the client devices in a group using a certain access point, a computing device that aggregates data from several access points, or a more centralized server that oversees many access points), and that tracking function may be shifted up, down, or laterally, depending on the requirements of the system. For example, if the computing device assigned to perform the tracking is experiencing connectivity problems, the responsibility for that tracking may be shifted up the hierarchy to a device not so affected. The analytic and control function assignment can change based on various factors, including for example whether an access point 404 is part of the system under test. The assignment can be based on a memory or processing capability of a device 402, 402′, 402″ or access point 404.

In various embodiments, the frequency and granularity of testing can change. For example, the frequency of testing (i.e., the periodicity of testing, or time between tests) may need to stay constant to identify a problem quickly. The granularity of the captured results (i.e., the level of detail investigated and/or captured during testing) may vary dramatically to avoid waste (e.g., scan data results). Frequency may need to be reduced and granularity may be held constant (e.g. testing of throughput results). Both frequency and granularity of testing may be adjusted or held constant.

The control server 408 is responsible for oversight of the system and decision-making, such as allocation of computing resources and storage, monitoring and reporting overall network status, assigning testing tasks to client devices, and receiving, storing, and analyzing network performance data from client devices. However, because the system 400 is distributed by design, many of these tasks can be shifted to the client devices 402, 402′, 402″, utilizing spare computing resources and storage on the client devices 402, 402′, 402″, such as idle processor time or a configurable percentage of available storage space. For example, the control server 408 can configure client devices 402, 402′, 402″ via remote instruction regarding which tests to run, how frequently such tests should be run, and thresholds for testing and reporting, and schedules and other conditions for reporting data. The application on the client devices 402, 402′, 402″ can then run in the background, independently conducting system testing as configured by the control server 408, analyzing results, storing test results locally, and reporting them as scheduled.

In this case, the client devices 402, 402′, 402″ act as independent agents, gathering, analyzing, storing, and reporting data. Alternately, the control server 408 may take a more active role, directly instructing client devices 402, 402′, 402″ to run certain tests and report the results, with the control server 408 storing the data and conducting the analyses. In this case, the client devices 402, 402′, 402″ are used like sensors that simply report back their data to the control server 408. This is just an example, a wide range of such allocations is possible, which gives the system 400 tremendous flexibility in responding to changing network conditions.

The service 406 can be any type of service, platform, system, or device that allows access by one or more client devices 402, 402′, 402″ through one or more access points 404. For example, the service 406 can be a mobile phone service whose access points are cellular towers. The service 406 can also be online cloud computing platform accessible via any access point that provides access to the Internet. The service 406 can also be a cloud-based virtual private network (VPN) networking system with access points owned by the cloud-based VPN or the client. This can be, for example, a cloud-based VPN connecting a company with multiple regional offices, each of which has its own local access points. As another example, this can be a local network controller device with access points such as a single office company with a network controller and a plurality of access points.

Access points 404 can be devices capable of receiving and re-transmitting wireless signals from client devices 402, 402′, 402″. Typically, these can be dedicated devices such as wireless routers and cellular towers, but can also be client devices 402, 402′, 402″ which can be configured to act as access points 404.

The client devices 402, 402′, 402″ can be any of numerous known devices capable of wireless communication. For example, the client device 402, 402′, 402″ can be mobile phones, desktop computers, tablet computers, internet of things devices (IoT), etc. There may be multiple instances of each type of device 402, 402′, 402″ in any given configuration in the system 400. Unlike access points 404, client devices 402, 402′, 402″ can have general-purpose computing capabilities, which can be configured to perform network testing activities and report results back to the control server 408, using, for example, a software application installed on the client device that can be configured or controlled by the control server 408. However, some client devices 402, 402′, 402″, for example, IoT devices, may have more limited capabilities and yet can still be used as client devices 402, 402′, 402″.

In some embodiments, the client devices 402, 402′, 402″ can be configured to use an open API, enabling use of the client devices 402, 402′, 402″ with different types of, or multiple operators of, control servers 408. In other words, the client devices 402, 402′, 402″ can be configured to provide network performance testing and data to multiple different control servers 408 which may have different owners or operators. For example, the application installed on client devices 402, 402′, 402″ can run tests for, and provide data to, an operator of one network when certain access points are accessed and run tests for, and provide data to, an operator of a different network when other access points are used. Many different configurations are possible, allowing the client devices 402, 402′, 402″ to be used as a roaming network performance testing unit and data provider, which can be a service subscribed to by operators.

The control server 408 can assign different operational modes to different client devices 402, 402′, 402″ depending on network conditions or the types of testing desired. For example, the control server 408 may dynamically assign active or passive test execution to client devices 402, 402′, 402″ based on any network condition or type of testing desired, for example: desired voice, video, or throughput test coverage per access point, per network per client type (e.g. Windows vs Mac operating systems and platforms), or per client configuration/capability, or server connectivity and latency per server by ping or web downloads, etc.

In some embodiments, the control server 408 may base configurations or operating modes of client devices 402, 402′, 402″ on statistical sampling methods to ensure representative sampling large enough to achieve statistical significance across the client device 402, 402′, 402″, access points 404, and network population while minimizing the active test processing load on the network and client devices 402, 402′, 402″. The testing configurations and operational modes assigned by the control server 408 can be further organized by population groups (e.g. a particular customer organization) to optimize the network performance management for the client device 402, 402′, 402″ type mix (e.g., high/low bandwidth connections, high/low spare processing power, frequently connected/disconnected, etc.) enabling optimal client device and network coverage while minimizing the number of connected clients devices needed to achieve representative network performance data. The testing configurations and operational modes assigned by the control server 408 can be further organized by error rate thresholds by test type, physical (street) location, access point groupings at a particular location, client device capabilities, network type, and other network conditions.

In some embodiments, the control server 408 or other system components can provide reporting of network conditions to administrators through a variety of means, including, but not limited to, email, webhook, SMS, push-enabled communication services, and/or other publishing mechanisms supported by the network (e.g., REST calls). This does not exclude obtaining certain reported data through other means, such as phone calls by a customer to a help desk to report a network performance problem.

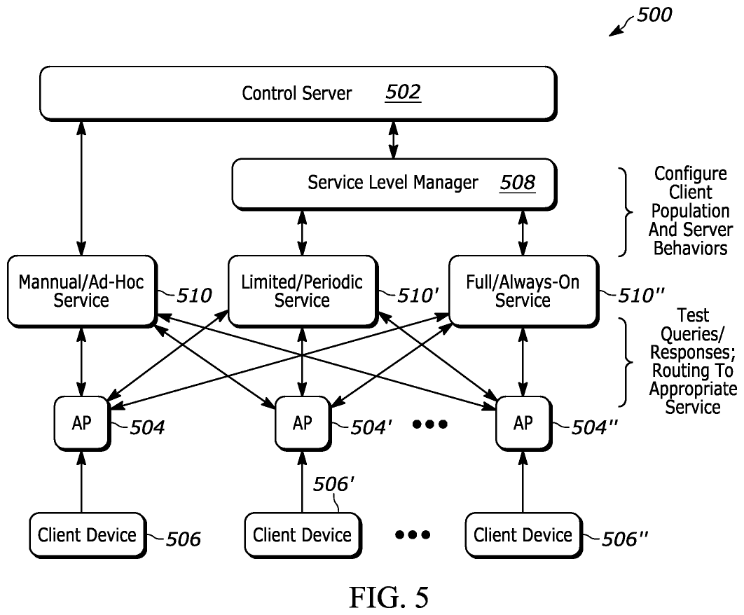

FIG. 5 illustrates an embodiment of a system architecture for a distributed network performance management system 500 that uses services levels to control the volume and flow of network testing traffic of the present teaching. This system includes elements similar to those described in connection with FIG. 4 including, a control server 502, access points 504, 504′, 504″, and client devices 506, 506′ and 506″ which can operate in a manner similar to the control server 408, and access points 404 and client devices 402, 402′, 402″ which are described in connection with FIG. 4. However, the system 500 includes service levels added to differentiate and control the volume of network performance testing traffic and to help ensure statistically valid sampling of larger networks. A service level manager 508 is included between the control server 502 and access points 504′, 504″ to manage the level of service provided to certain groups of client devices. This can be, for example, particular company-owned mobile devices in a given company. The service level manager 508 can take some of the load from the control server 502 such as configuring client devices 506′, 506″ and their operating modes, depending on the level of service that a particular organization has contracted.

In some embodiments, for example when client devices 506, 506′, 506″ are mobile devices, the client devices 506, 506′, 506″ may not always connect through the same access points 504, 504′, 504″, so the network performance testing data from each client device 506, 506′, 506″ can be routed to an appropriate service level handler 510, 510′, 510″ for an organization based on a client device identifier, which can be, for example, a MAC address or some other identifier.

In some embodiments, a manual or ad-hoc level of service 510 can be provided. For individual client devices 506, 506′, 506″ or small groups of client devices 506, 506′, 506″, for example, statistical sampling methods may be irrelevant, or the level of network performance testing traffic may be high in relation to available bandwidth, or the cost of a higher level of service may be too great. In such cases, the client device 506, 506′, 506″ can be configured to perform network testing either at the request of the user of the client device 506, 506′, 506″, or can be triggered only by network conditions indicating poor network performance. In some embodiments, the client device 506, 506′, 506″ can be configured such that the user of the client device 506, 506′, 506″ can initiate a network performance test, see the results, and/or have the test results sent directly to a support center, such that when the user calls the support center, the support center staff have test results for that particular device available to assist with troubleshooting the problem of the user.

In some embodiments, the client device 506, 506′, 506″ can be configured to perform a voice/audio test, wherein a voice or audio sample is sent to and received from a server, analyzed for audio quality, and the client device provides an indication of voice/audio quality (e.g., a green, yellow, or red indicator). In some embodiments, if the client device 506, 506′, 506″ detects a major network or connectivity problem, the client device can automatically notify the user of the nature of the problem. For example, this notification can occur if the client device has lost its connection with its domain name system (DNS) server, and thus has no Internet access. The client device can even provide the user with a support center phone number to call to report the problem and get help.

In some embodiments, a limited or periodic service 510′ can be used. For mid-sized groups or organizations, statistical sampling may be relevant, but the cost of “always on” or full service may be too high, in which case limited or periodic testing may provide acceptable network performance management in terms of balancing of cost, bandwidth utilization, and sufficient network performance testing detail. For example, a limited service 510′ can run most tests on user demand and results may be submitted to their configured destination, which can be a help desk. The limited service 510′ can perform connectivity testing on an “always-on” basis, but submit results only on user demand. The limited service 510′ can locally store test result history which can be collected periodically by control server. The limited service 510′ can periodically change some client devices 506, 506′, 506″ to the full-service operating mode to gather additional data in response to certain network events.

In some embodiments, a full or always-on service 510″ can be used. For large-sized groups or organizations, networks may be large, and maximization of network performance (or reliability) may be a key concern. In such cases, the ability to capture an appropriate level of detail will be critical. Also, in such cases, a full or always-on service 510″ can be utilized, in which data are continuously sampled from a statistically-representative sample of the client devices 506, 506′, 506″ on that network, and continuously managed by the service level manager 508. A full service manager 510″ can, for example, run tests on a schedule based on their test profile instructions. The full service manager 510″ can perform passive tests run on a configurable schedule, often as frequently as the platform allows. Also, the full service manager 510″ can perform active tests on a configurable schedule. A full-service service level 510″ can have connectivity testing “always-on” with results submitted continuously.

In all service levels 510, 510′, 510″, client device monitoring and reporting of network performance can be dynamically scaled according to network conditions. For example, networks tend to perform acceptably most of the time, so gathering of large amounts of network performance data during periods of good performance simply wastes computing and storage resources. However, when problematic network events do occur, it is often necessary to gather more detailed data to troubleshoot the problem. The control server 502 and/or the service level manager 508 may dynamically instruct client devices 506, 506′, 506″ to perform additional and more frequent testing if reported data indicate a network problem.

Alternately, the client devices 506, 506′, 506″ themselves can be configured to dynamically adjust the types and frequency and granularity of testing to increase the level of detail available if a network problem is indicated. By granularity, we mean the level of detail captured during testing. In some cases, for example, when there is poor connectivity or throughput, these additional data can be stored locally on the client devices 506, 506′, 506″, and then reported after the network problem improves. As examples of such operation, client devices 506, 506′, 506″ can be configured to summarize and store test results and analysis which fall in acceptable performance range in local storage for a configurable time period. The test results can be detailed and stored for analysis to determine if results fall outside acceptable performance range in local storage for a configurable time period.

In some embodiments, client devices 506, 506′, 506″ are configured to operate as a stand-alone client device. In these embodiments, the client devices 506, 506′, 506″ may be configured to send a notification to “help-desk” or other consumer of problem information, for example, network team etc. Also, in some embodiments, client devices 506, 506′, 506″ can be configured to provide anonymous data to the control server 502.

One feature of the method of determining wireless service quality in a shared environment of the present teaching is that it can be used to improve network performance in a shared environment in an automatic, semi-automatic, and/or manual fashion. In some embodiments, any or all of the control server 502, service level manager 508, and/or services 510, 510′, 510″ can be configured to react to an inferred level of wireless service quality and automatically, semi-automatically, and/or manually improve the level of wireless service. For example, any or all of the control server 502, service level manager 508, and/or services 510, 510′, 510″ can be configured to determine a network problem associated with the level of wireless service, which could be, for example, a roaming problem, a coverage problem, a communication congestion problem, a rogue device problem, a connectivity problem, and/or a wireless interference problem. In addition, any or all of the control server 502, service level manager 508, and/or services 510, 510′, 510″ can optionally be configured to make changes to the network and/or to network components to resolve the problem, thereby improving a level of wireless service quality. Examples of changes to the network are adding or removing client devices from the network and adding networking hardware resources.

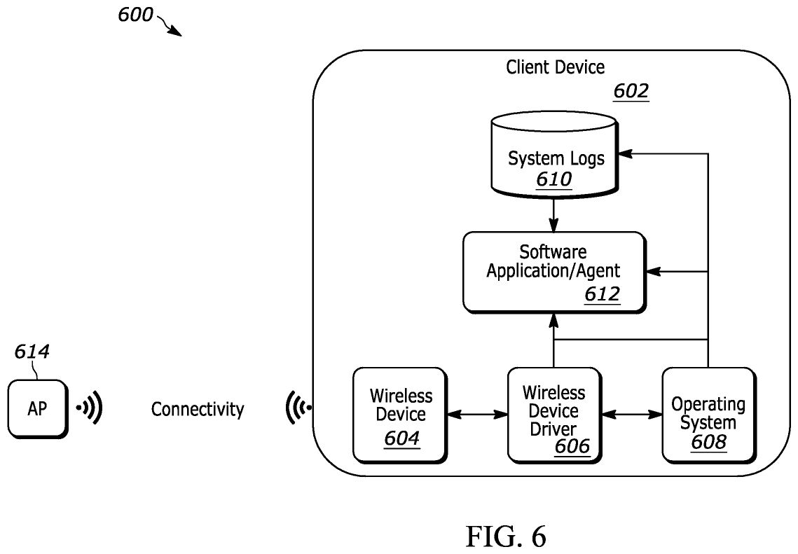

FIG. 6 illustrates an embodiment of a data capture system 600 for a client device 602 that does not support data capture of the present teaching. Client device 602 is shown with certain key components for capturing connectivity and network performance data. It should be understood that the present teachings described in connection with FIG. 6 and other figures also apply to wired communications, such as devices that are hard wired to networks through Ethernet connections or similar computer wired networks protocols. A wireless device 604 can be a hardware device containing a wireless radio with receive and transmit capabilities. The wireless device 604 can be configured to use any of numerous types of wireless frequencies and protocols, including, but not limited to WiFi, Bluetooth, and cellular. A wireless device driver 606 is installed on the client device 602 that includes software that allows an operating system 608 to interface with, and control the operation of, the wireless device 604.

System logs 610 are stored by the operating system 608 and other components of the client device 602 containing details regarding operation of the client device 602 and its components. System logs 610 often contain useful information about connectivity and network performance.

A software application/agent 612 is installed on the client device 602 to gather, analyze, and report connectivity and network performance data for the client device 602. The software application/agent can be referred to as either a software application or a software agent when used in this fashion. The software application/agent 612 typically runs as a background process, and is not visible to the user, except when providing network status reports to the user.

The software application/agent 612 may either passively monitor the wireless device driver 606, the operating system 608, and the system logs 610 for network performance data, and/or may conduct active network testing. When the wireless device 604 attempts to connect with an access point 614, the software application/agent 612 can gather data regarding network events, conditions, and performance issues such as, but not limited to type of wireless device hardware and firmware, version of wireless device driver, client device hardware and software, operating system type and version, type of connection (e.g., WiFi, Bluetooth, etc.), speed of connection (which can be determined by handshake), failed 802.11 authentications, DNS failures, no IP address/bad IP address, and no internet connectivity, etc. The software application/agent 612 can perform network performance analyses on the data such as signal strength, nominal connection speed, throughput speed, and the like, and may perform calculations such as average, mean, and mode, or percentile, quartile, etc., of certain metrics. Changes to metrics over time may be recorded and correlated with network performance impacts. In some embodiments, the software application/agent 612 can be configured with a wireless performance monitor that uses packet and frame filtering to extract and infer network performance data that are either not otherwise available or are not supported by any other components or functionality of the client device 602.

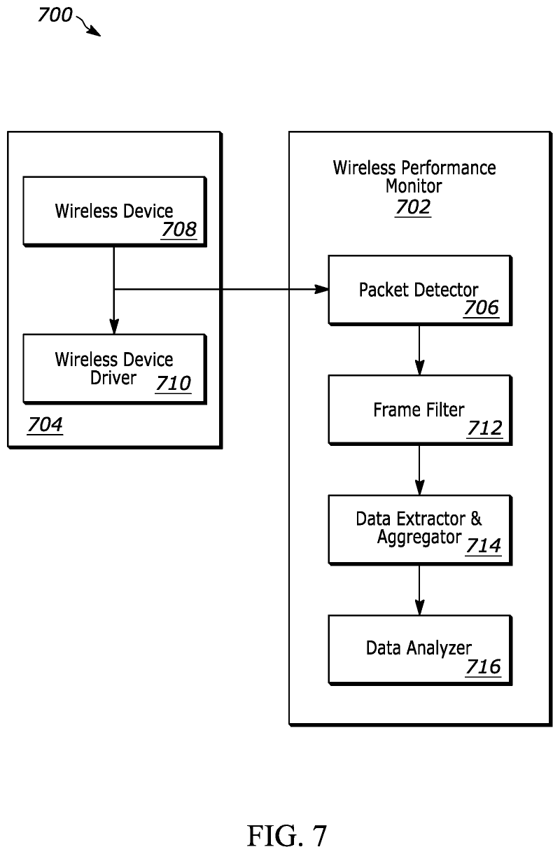

FIG. 7 illustrates an embodiment of an architecture of a system 700 for wireless performance monitor using a wireless performance monitor device 702 that is separate from the monitored client device(s) 704. A wireless performance monitor device 702 can use packet and frame filtering to extract and infer network performance data that are either not otherwise available or are not supported by any other components or functionality of a client device 704. A packet detector 706 can be a dedicated hardware unit or software running either on a wireless device or a computer to which a wireless device is located, and can be configured to intercept or receive packets from a wireless network for further analysis. In some embodiments, packets are intercepted as they are sent from a wireless device 708 in a client 704 to a device driver 710 in that client 704 for further interaction with an operating system (not shown) in the client 704.

A frame filter 712 connected to the packet detector 706 operates on raw packet data received from a packet detector 706. The frame filter 712 filters out frame data that do not contain useful information (for example, empty/null frames). A data extractor and aggregator 714 connected to the frame filter 712 extracts and aggregates relevant data from packets, such as data rates and retry rates. The data extractor and aggregator 714 is connected to a data analyzer 716. The data analyzer analyzes the extracted and aggregated data from packets to determine wireless network performance, for example, actual throughput versus nominal data rates.

The wireless performance monitor 702 can monitor and evaluate wireless configurations and capabilities via protocol packet analysis, noting changes over time and correlating with performance impacts. By analyzing frame data from wireless data packets, the wireless performance monitor 702 can extract information about connectivity and network performance that is typically not reported by any other client device 704 system, including the operating system. For example, depending on the information contained in the frames, the wireless performance monitor 702 may be able to extract such information as an access point's vendor identity, the access point's capabilities, data rates supported, the network type/mode (e.g., for WiFi connections, 802.11 a/g/n/ac/ax), features supported (e.g., for WiFi connections, 802.11 k, v, r), and other similar information.

In some embodiments, the wireless performance monitor 702 can be used to infer information not supported by a client device 704 or not provided by the client device 704 with sufficient accuracy. In some embodiments, for example, the wireless performance monitor 702 can be configured to infer the modulation and coding scheme index (MCS index) for a given wireless connection. Each MCS index represents a set of frequency, streams, modulation, and coding that establish the maximum data rate/bandwidth that can be achieved using that index, and is an important piece of information in evaluating certain wireless network performance metrics.

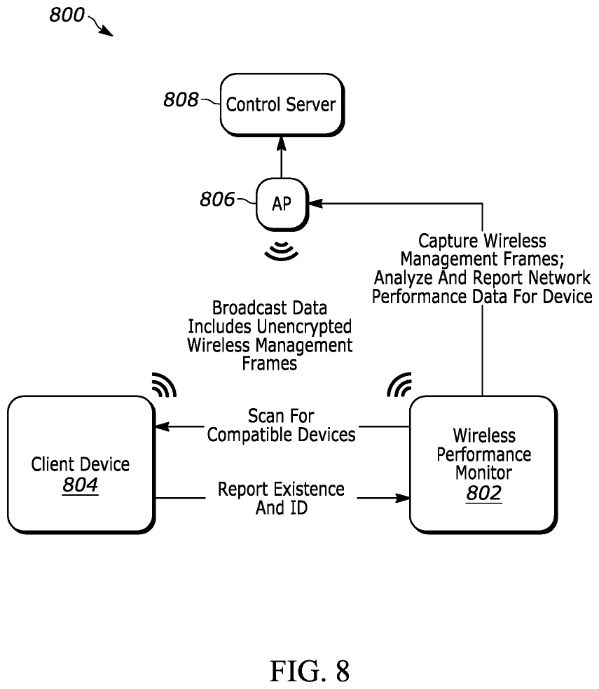

FIG. 8 illustrates an embodiment of an architecture of a distributed network performance management system 800 including a wireless performance monitor 802 that is separate from the monitored client devices 804. The wireless performance monitor 802, that can also be referred to as an external monitoring device, captures and reports network performance data for a different client device 804 that has limitations or restrictions on network data reporting. The monitored client devices 804 can be referred to as limited or restricted devices. The client device 804 and the wireless performance monitor 802 are connected via wireless connections to an access point 806, which is connected to a control server 808. An example of a client device 804 that has limited or restricted access is an Apple iPhone™, which uses a proprietary operating system that does not allow users or developers to access the device's data about its network performance and connectivity. This limited or restricted access is a significant challenge for performance management for many reasons, but is particularly problematic when attempting to use a client device 804 to report network performance data within the system 800 for network performance management purposes. As such, the wireless performance monitor 802 is needed to capture, analyze, and report wireless network performance data for the limited or restricted device, client device 804.

In some embodiments, the wireless performance monitor 802 scans for compatible devices, which are devices that have a particular application installed, or are part of a VPN or other service that includes external monitoring devices, such as the wireless performance monitor 802. The client device 804, being such a compatible device, reports its existence and identification to the wireless performance monitor 802. The wireless performance monitor 802 can capture wireless management and control frames, which are unencrypted wireless data packets sent between devices, such as the access point 806 and the client device 804, to manage and control their communications.

The wireless management and control frames are distinguished from the data frames in that the wireless management and control frames must be heard and understood by all clients and, therefore, must be transmitted as open or unencrypted to allow negotiation of communications. In contrast, the data frames intended for a specific device after communications have been negotiated, and may be encrypted. The wireless performance monitor 802 can capture all wireless frames, identify those associated with the client device 804 using the reported identification, analyze the wireless management, and control frames for network performance data such as the MCS index, number of retries, etc., and report network performance data to the control server 808 on behalf of the client device 804. If data frames are unencrypted, the wireless performance monitor 802 can also use data frames to report network performance data such as throughput, actual data-rate etc. to the control server 802.

In some embodiments, the client device 804 is limited or restricted for another reason than having a proprietary operating system. For example, the client device 804 can be an Internet of Things (IoT) device which is capable of logging connectivity data, but that has limited processing power and storage, no geolocation awareness, and/or cannot perform analyses of the connectivity data. As such, the client device cannot report its connectivity data to the control server 806 through the access point 806. In such a case, the wireless performance monitor 802 can be provided with an identifier for the client device 804, and can intercept wireless frames, identify those associated with the client device 804, and analyze and report network performance data to the control server 808 on behalf of the client device 804, as noted above. In some embodiments, the wireless performance monitor can be a more capable client device with general purpose computing capabilities, such as a mobile phone or desktop computer.

In some embodiments, the client device 804 can be configured to broadcast (either periodically or continuously) data regarding its connection with the access point 806 along with a device identifier, which broadcast can be received by the wireless performance monitor 802, and transmitted to the control server 808, either through the same access point 806 or a different access point (not shown).

In some embodiments, the client device 804 can be a device with limited processing or storage capabilities, such an internet of things device like an internet-capable television or an embedded system, such as an internet-capable weather checking system on an irrigation controller. In such cases, the client device 804 has limited analysis and reporting capabilities, but may be able to send connectivity data and a device identifier to another device for analysis and reporting. In these embodiments, the client device 804 is an IoT device, and is connected to the access point 802, which is connected to the control server 808. The IoT client device 804 has a device identifier and is capable of logging connectivity data, but has limited processing power and storage, no geolocation awareness, and cannot perform analyses of the connectivity data, and may not be able to report its connectivity data to the control server 808 through the access point 806. The IoT client device 804 can be configured to simply broadcast (either periodically or continuously) data regarding its connection with the access point 806 along with a device identifier, which broadcast can be received by a more capable client device with general purpose computing capabilities, wireless performance monitor 802, that can be a mobile phone or desktop computer.

The wireless performance monitor 802 can be connected to the control server 808 through the same access point 806 or a different one, and can perform the analysis and reporting on behalf of the IoT client device 804. Thus, the control server 808 gains the benefit of the connectivity data from the IoT client device 804, as analyzed and reported by the wireless performance monitor 802, whose connectivity to the network may or may not be significant to managing network performance.

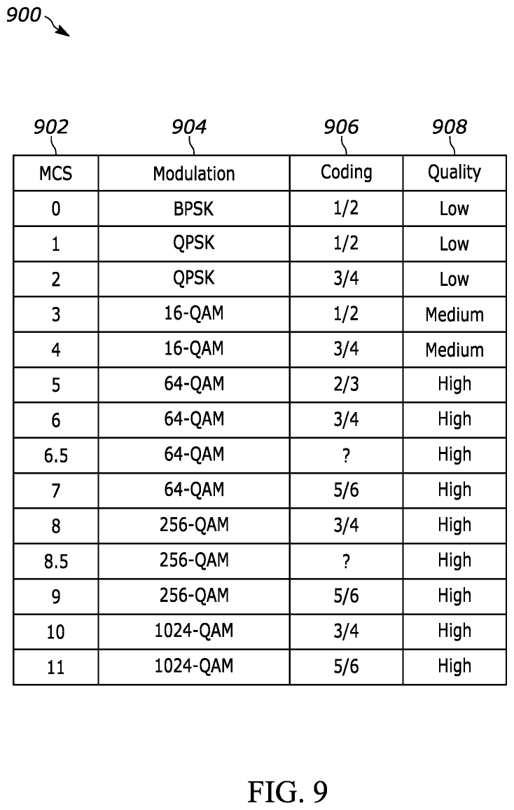

One feature of the present teaching is that it goes beyond known systems and methods of determining wireless quality using indexed modulation and coding schemes (MCS). FIG. 9 illustrates a Table 900 that indexes 902 specific MCS, including both the modulation scheme 904 and the coding scheme 906, to a quality metric 908. The index runs from zero to eleven. The quality metric 908 is low, medium or high. For example, when a wireless client is operating in MCS 11, 1024-QAM with coding rate of ⅚, the RF environment is highly likely of high quality. This is because, for example, amplitude modulated and high-density modulation schemes using higher coding rates are possible when the links are low noise and/or have low interference. As such, this quality metric value can be true to an acceptable degree of certainty even without more detailed knowledge of the client device or the RF environment.

On the other hand, when a wireless client is operating with MCS index 9, a BPSK modulation and coding rate of ½, the RF environment is highly likely of low quality. This is because, for example, phase modulated and low-density modulation schemes using lower coding rates are used when the links are higher noise and/or have high interference. Again, this low-quality metric value is true to an acceptable level of certainty without detailed knowledge of the RF environment, but may not be correct in different RF environments. The MCS indexes 902 for wireless quality in the Table 900 have a known blind spot for certain platforms, for example Windows™ platforms. The MCS indexes 902 for wireless quality in the Table 900 do not incorporate specific platform dependent variations in wireless devices. The MCS indexes 902 for wireless quality in Table 900 do not take account for the range of speeds and performances of client devices. Also, MCS indexes 902 for wireless quality scoring do not account for any scheduling or other multiuser technology functions. For example, next generation WiFi systems use multiuser scheduling to improve capacity and performance. One feature of the present teaching is providing a wireless quality score that overcomes the limitations of wireless quality scoring systems and methods, such as MCS index 902.

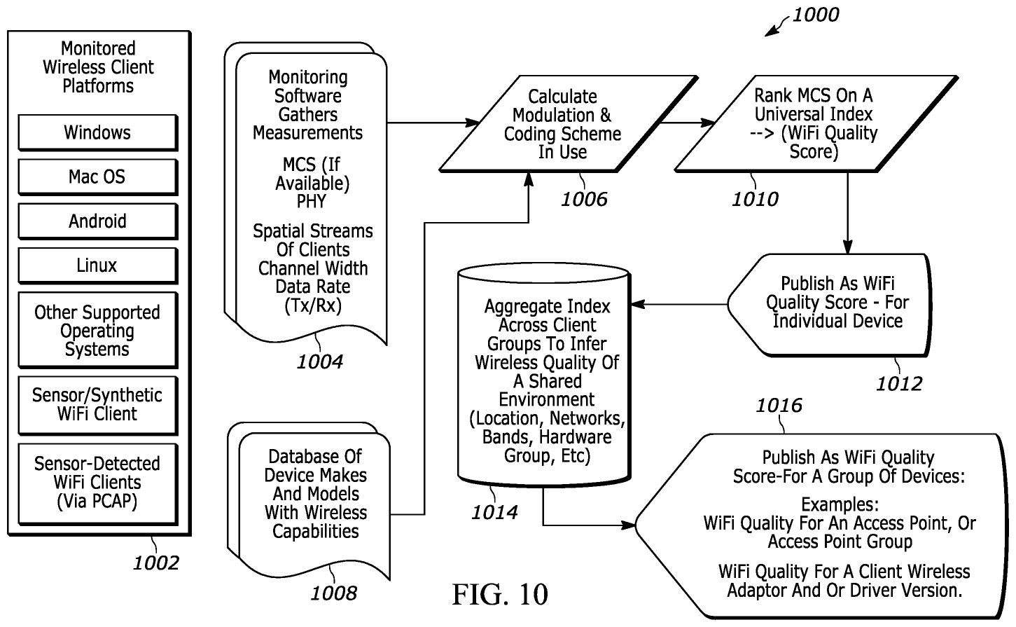

FIG. 10 illustrates a functional block diagram of an embodiment of a system 1000 for determining wireless platform quality using inference of the present teaching. The system 1000 can operate, for example, using the management systems, client devices, monitor systems, and services described herein. The system 1000 includes a number of monitored wireless client devices 1002 that use different wireless platforms. These client devices' 1002 performance is inferred and used by the system 1000. The client devices 1002 can be WiFi-based client devices. The wireless platform of these client devices 1002 can include, for example, Windows™, MacOS™, Android™, and Linux™. For example, the wireless platform of these client devices 1002 can also include other known operating systems, sensor and/or synthetic WiFi systems, and/or sensor-detected WiFi clients via packet capture (PCAP). Client devices 1002 can be, for example, client device 202 described in connection with FIG. 2, client devices 402, 402′, 402″ described in connection with FIG. 4, client devices 506, 506′, 506″ described in connection with FIG. 5, client device 602 described in connection with FIG. 6, client device 704 described in connection with FIG. 7 and/or client device 804 described in connection with FIG. 8.

The system 1000 can be operated in a distributed system architecture. As such, the various functions, described further below, of system and 1000 can operate from various elements of the management system described herein, including control servers, access points, client devices and/or performance monitors, as described, for example, in connection with the descriptions associated with FIG. 2 and FIGS. 4-5. An advantage of having various functions operating lower in the hierarchy is that a larger more distributed set of touch points in the network are potentially available. Another advantage is that the storage and memory burden is spread across more devices.

An advantage of having various functions operating higher in the hierarchy is that is supports client devices with less functionality. Another advantage of having various functions operating higher in the hierarchy is that at least some of the data is localized for processing efficiency. In some embodiments, the locus of the location of the functions can change over time based on, for example, changing RF conditions, changing management requirements, changing client devices, changing system architectures and other factors.

The system 1000 includes a monitor function 1004 that gathers measurements from and about the client devices 1002 in a managed network within a shared environment. A managed network includes devices being managed by a particular management system instance. A shared environment describes devices that are sharing, for example a location, communications bands, and/or hardware groups. A shared environment can also refer to shared access point or group of access points. A shared environment can also refer to a managed system domain. A shared environment can also refer to all or some of a shared RF spectrum. A shared environment can also refer to a shared wireless service provider. The monitor function 1004 can be provided either by the client device itself or by using an external monitor. The external monitor can be, for example the wireless performance monitors 702, 802 described in connection with FIGS. 7-8. Using an external monitor supports the identification of the modulation and coding scheme in use for a given client even when it is not reported by the system.

One feature of using external monitors in addition to client device information is that it supports cross-sensor test coordination to improve the ability to determine wireless quality especially for wireless systems that include a scheduler. For example, cross-sensor test coordination including voice and throughput to stress the scheduler can be used. Different monitors can also be used together, for example, two or more of a cellphone client device 202 described in connection with FIG. 2, a mobile monitor such as module 324 described in connection with FIG. 3, wireless performance monitor 702 described in connection with FIG. 7 and/or wireless performance monitors 802 described in connection with FIG. 8.

The gathered measurements can relate to MCS information, physical layer (PHY) information, spatial stream information, channel width information, data rate information and/or other information. As such, unlike known systems, the system and method of the present teaching supports inference of wireless link quality from the results of a client device's natural data rate shifting and that accounts for differing client device and network capabilities, rather than a generic modulation and coding scheme. A modulation and coding scheme determination function 1006 processes gathered measurements to calculate modulation and coding scheme(s) that are in use. The MCS determination function 1006 can get additional information to determine the MCS from a database 1008 that contains device makes and models and their associated wireless capabilities. A ranking function 1010 produces an individual quality metric value, also referred to as an individual quality score, for each measured client device.

In some embodiments, the ranking function produces an index for each measured client in an environment that is used to determine the quality metric value. That is, the index is valued based on a quality of a wireless connection that is based on the unique capabilities of the wireless driver and/or other software that runs the wireless transmitter. For example, the index can be valued based on a quality of a WiFi connection based on the unique capabilities of a Windows™, MacOS™, Android™ or Linux™ device. The index can be a universal index, thus ensuring uniformity of the quality score across different networks. The index can also be based on devices' age and/or maximum performance potential. A publish function 1012 publishes the individual quality scores. An aggregation function 1014 aggregates the individual quality scores across client groups to determine a wireless quality score in a shared environment that is inferred at least in part based on the aggregated individual quality scores obtained from client devices in that shared environment.

A group publish function 1016 publishes a determined wireless quality score for the shared environment. For example, the wireless quality score can be a WiFi quality for an access point. The wireless quality score can be a WiFi quality score for an access point group. The wireless quality score can be a WiFi quality score for a client wireless adaptor. The wireless quality score can also be a WiFi quality score for a client wireless driver version. The wireless quality score can also be a score for combinations of the above. These are just some of many possible quality scores. The wireless quality score can provide a calculated value of a wireless quality for a particular group of managed wireless devices and functions such that all or some of the group can be controlled and managed to provide a desired performance of all or some of the group. As one example, a wireless quality score that is good or high can allow a managed client device to operate with lower power, faster coding rate and/or higher modulation rate as compared to if the wireless quality score is low or medium. As another example, a wireless quality score that is good or high can allow a managed access point to attach to more clients as compared to if the wireless quality score is low or medium.

Referring also to FIG. 10, an embodiment of a method of the present teaching in a first step obtains information about each wireless client's capabilities and wireless connection in a shared environment. This step, can comprise implementing the monitor function 1004. This information can be provided directly from the client device and/or this information can be derived by looking at wireless transmissions from the device. Each measured client in an environment can be referred to as a client sample.

A second step 1006 of the method calculates the modulation and coding scheme in use for each client sample. In an optional third step 1008, additional data that is required to provide and/or correct the wireless capabilities information for a specific measured wireless client is gathered to improve the calculation of the modulation and coding scheme in use for each client sample. In a fourth step 1010, the modulation and coding scheme in use is ranked on a common index that is based on a platform associated with the wireless client. In addition, the common index is determined independent of physical layer, spatial streams and channel width considerations.

In a fifth step 1014, the method infers the quality of the wireless connection between that client and the associated wireless access point using the ranked modulation and coding scheme of each wireless client.

In a sixth step 1016, the method infers the quality of the radio frequency environment in a physical location using the ranked modulation and coding scheme of each wireless client in a group of wireless clients. For example, the grouping can be by wireless access point or the grouping can be by access point group. In this way, the method accurately infers wireless link quality from the results of clients' natural data rate shifting, accounting for differing client and network capabilities. The wireless system can be a WiFi system.

One feature of the present teaching is that the determined wireless quality score for a shared environment can be used to identify and mitigate problem root cause in a managed wireless network. The system and method can provide association-based problem identification based on the determined wireless quality score. The system and method can also provide scan-based problem identification. For example, the roaming performance of a wireless client can be determined based on the information from data sources provided by the client operating system and subsystems. The difference between an expected and actual wireless quality score can lead to identification of, for example, a sticky client, 802.11r fast transition performance problem, 802.11v basic service set (BSS) transition performance problem, 802.11k neighbor report performance problem, BSS transition time and/or re-association failures.

The difference between an expected and actual wireless quality score can lead to identification of coverage issues. That is, the system and method can be used to infer the existence of a coverage problem for a Wi-Fi client from the data sources provided by the client OS and subsystems. Additionally, the system and method can be used to infer existence of a congestion problem for a Wi-Fi client, from the data sources provided by the client OS and subsystems. For example, the congestion problems can be identified based on a quality of service enhanced basic service set (QBSS) channel utilization. The difference between an expected and actual wireless quality score can lead to identification of interference that can include both WiFi and non-WiFi interference. The difference between an expected and actual wireless quality score can detect external network rogue access points.

The sampling time of data collection in the system can be dynamically adjusted based on connection quality, that is wireless quality score at a point in time. Further, the measurement sampling can include statistical sampling. The system can also include a sensor dedicated to passive client performance monitoring.

One feature of the present teaching is that it can allow for the modulation and coding scheme in use by wireless clients to be identified from limited data available various operating systems and device types. Another feature of the present teaching is that it can simplify and standardize the modulation and coding schemes used by 802.11 wireless clients, so that measurements taken from diverse operating systems and device types can be reasonably compared and correlated. Another feature of the present teaching is that is can present a single, aggregated “Wi-Fi Quality Score” key performance indicator obtained from diverse client platforms and hardware.

Another feature of the present teaching is that it can identify and correlate Wi-Fi connection quality in a shared RF environment more quickly than known systems and methods. For example, it quickly measures and scores the quality of the RF environment around an access point, or group of access points, that a group of measured clients are able to hear. Another feature of the present teaching is that it can compare the performance of two or more groups of clients in a shared RF environment, based on client differences. For example, relative performance of different wireless adaptors, or driver versions. This is not possible, for example, by using the MCS index described in connection with FIG. 9.

### EQUIVALENTS

While the Applicant's teaching is described in conjunction with various embodiments, it is not intended that the applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A method of determining wireless service quality in a shared environment, the method comprising:
a) receiving a wireless transmission from a client device in the shared environment;
b) processing the received wireless transmission to determine a client modulation-and-coding scheme and a client device attribute associated with the client device;
c) calculating a rank of the client device using the client sample wherein the rank is based on a universal index that is related to the client modulation-and-coding scheme and to the client device attribute; and
d) inferring a wireless service quality of the shared environment based on the calculated rank of the client device.

2. The method of claim 1 further comprising identifying a network problem based on the inferred wireless service quality.

3. The method of claim 2 wherein the identified network problem comprises at least one of a roaming problem, a coverage problem, a communication congestion problem, a rogue device problem, a connectivity problem, or a wireless interference problem.

4. The method of claim 1 further comprising performing step a) through step c) for a second client device in the shared environment, thereby calculating a rank of the second device.

5. The method of claim 4 wherein inferring the wireless service quality of the shared environment comprises inferring the wireless service quality of the shared environment based on the calculated rank of the client device and the calculated rank of the second client device.

6. The method of claim 5 wherein the client device and the second client device share a wireless access point.

7. The method of claim 1 wherein receiving the wireless transmission from a client device in the shared environment comprises receiving using an external monitor.

8. The method of claim 1 wherein processing the received wireless transmission to determine the client modulation-and-coding scheme and the client device attribute associated with the client device comprises processing using statistical sampling.

9. The method of claim 1 wherein the client modulation-and-coding scheme comprises a PSK modulation scheme.

10. The method of claim 1 wherein the client modulation-and-coding scheme comprises a QAM modulation scheme.

11. The method of claim 1 wherein the client modulation-and-coding scheme comprises a rate ½ code.

12. The method of claim 1 wherein the client modulation-and-coding scheme comprises a rate ⅚ code.

13. The method of claim 1 wherein the client modulation-and-coding scheme comprises a rate ¾ code.

14. The method of claim 1 wherein the client modulation-and-coding scheme comprises a rate ⅔ code.

15. The method of claim 1 wherein the client modulation-and-coding scheme comprises a rate ½, a rate ⅚, a rate ¾, and a rate ⅔ code.

16. The method of claim 1 wherein the client modulation-and-coding scheme comprises at least one of a rate ½, a rate ⅚, a rate ¾ or a rate ⅔ code.

17. The method of claim 1 wherein the client device attribute comprises an operating system of the client device.

18. The method of claim 1 wherein the client device attribute comprises a platform of the client device.

19. The method of claim 1 wherein the client device attribute comprises a data-rate shifting of the client device.

20. The method of claim 1 wherein the shared environment comprises one of a shared location, a shared access point, a shared management system domain, a shared communications channel or a shared RF spectrum.

21. The method of claim 1 wherein the wireless transmission comprises a cellular transmission.

22. The method of claim 1 wherein the wireless transmission comprises a WiFi transmission.

23. The method of claim 1 wherein the wireless transmission comprises a Zigbee transmission.

24. The method of claim 1 wherein the wireless transmission comprises a Bluetooth transmission.

25. The method of claim 1 wherein the wireless transmission comprises a point-to-point transmission.

26. The method of claim 1 wherein the wireless transmission comprises a radio-frequency-based transmission.

27. The method of claim 1 wherein the wireless transmission comprises an optical transmission.

28. A system that determines wireless service quality in a shared environment, the system comprising:
a) a device configured to receive a wireless transmission from a client device in the shared environment;
b) a processor in communication with the device, the processor configured to:
i) process the received wireless transmission to determine a client modulation-and-coding scheme and a client device attribute associated with the client device;
ii) calculate a rank of the client device using the client sample wherein the rank is based on a universal index that is related to the client modulation-and-coding scheme and to the client device attribute; and
iii) infer a wireless service quality of the shared environment based on the calculated rank of the client device; and
c) a controller in communication with the processor, the controller configured to receive the inferred wireless service quality and to determine at least one wireless test based on the inferred wireless service quality.

29. The system that determines wireless service quality of claim 28 wherein the controller is further configured to identify a network problem based on the inferred wireless service quality.

30. The system that determines wireless service quality of claim 28 wherein the device comprises at least one of a WiFi device, an Ethernet device, a Zigbee device, a Bluetooth device, an RF communication device, or an optical communication device.

31. The system that determines wireless service quality of claim 28 wherein the client modulation-and-coding scheme comprises at least one of a rate ½, a rate ⅚, a rate ¾ and a rate ⅔ code.
